(19) United States
(12) Patent Application Publication
(10) Pub. No.: US 2001/0042348 A1
(43) Pub. Date: Nov. 22, 2001

(54) IMPROVED WINDOW SCREEN SYSTEM

(76) Inventor: DAVE B. LUNDAHL, FT. COLLINS, CO (US)

Correspondence Address: DEAN P EDMUNDSON, P.O. BOX 710, WINDSOR, CO, 80550, US

(21) Appl. No.: 09/326,405

(22) Filed: Jun. 4, 1999

(51) Int. Cl. E06B 3/32; E06B 3/28; E06B 3/26; E04B 1/00

(52) U.S. Cl. 52/202; 52/222; 160/89; 52/203

(57) ABSTRACT

A window screen system is described in which the screen or mesh periphery has secured to it a strip of hook and loop fastener material and the corresponding window frame has secured to it a mating strip of similar fastener material. The strip of fastener material on the outer edge of the mesh is aligned with and placed against the mating fastener strip which has been previously secured to the appropriate location on the window frame. Each side edge of the mesh can be stretched and then applied against the window frame, whereupon the mesh is held tightly in place on the window frame. No separate frame for the mesh is required. The mesh can be easily removed for cleaning, transport or storage.

### CROSS-REFERENCE TO RELATED APPLICATION

This application relates to and claims priority from my co-pending provisional application Ser. No. 60/093,122, filed Jul. 15, 1998.

### FIELD OF THE INVENTION

This invention relates to window screens. More particularly, this invention relates to systems for attaching and securing screens to window frames.

### BACKGROUND OF THE INVENTION

Traditional window screens involve the use of a rigid frame (typically composed of metal) which extends around the periphery of the screen mesh and secures the screen mesh edges. This screen frame is then spring loaded in grooves in the window frame or mechanically connected or secured to the window frame to hold the screen in place.

The traditional system involves a number of disadvantages and inherent limitations. For example, the installation, removal and storage of conventional window screens frequently results in bent frames or damage to the screen mesh. Also, the required aluminum screen framing elements reduce the visual opening of a window. Further, some types of window frames do not have an appropriate area to receive the normal metal framed screen or the window may not be rectangular in shape which renders the corner assembly or radius sections of the traditional metal screen frame problematic. Yet another disadvantage is that periodic maintenance may be required of the frame (i. e. painting, etc.).

U.S. Pat. No. 4,249,589 describes apparatus for mounting an environment-controlling screen, sheet or membrane. However, separate frame sections are required and they must be secured to the inner periphery of an opening. This arrangement inherently reduces the size of the viewing opening. The system is surface-applied in a location exterior of all vertically operating window elements.

U.S. Pat. No. 4,909,004 describes the use of a mesh screen for covering an opening in a structure (e.g. a garage). The screen is secured over the opening with VELCRO attachments, and a rain impervious sheeting is secured over the screen to increase the degree of enclosure of the structure in a selected amount and prevent wind and rain from passing through the screen.

U.S. Pat. No. 5,193,602 describes a roll up canvas cover for window frames that utilizes VELCRO pads to secure the canvas covering in a rolled up position or in a fully extended closed position.

U.S. Pat. No. 5,323,835 describes a removable screen for a car garage door. The top and sides of the screen are secured to the door casing with a VELCRO fastening system. A vertical zipper in the screen permits access into or out of the garage.

There has not heretofore been described a window screen system having the features and advantages provided by the present invention.

### SUMMARY OF THE INVENTION

In accordance with the present invention there is provided a frameless window screen system in which the screen mesh periphery has secured to it a strip of loop fastener material (i.e. VELCRO brand fastener material) and the corresponding window frame has secured to it a strip of the mating hook material. For example, the periphery of the screen or mesh may have secured to it a strip of the loop fastener material and the corresponding area of the window frame has secured to it a strip of the mating hook fastener material.

In order to affix the screen mesh to the window frame, the strip of fastener material on the outer edge of the mesh is aligned with and placed against the mating fastener strip which has been previously secured to a location on the window frame deemed most advantageous by the window designer. Each edge of the mesh includes a strip of the fastener material and each corresponding side of the window frame includes a strip of the mating fastener. Thus, each edge of the mesh can be stretched and then applied against the window frame, whereby the mesh is rendered taught and held tightly in place on the window frame regardless of its shape.

With the system of this invention, no separate rigid frame is required for the mesh or screen. Thus, the mesh can be easily removed for cleaning, transport or storage. The mesh can be easily rolled or folded and therefore it is mush easier to work with than conventional metal framed screens. Also, there is no rigid frame to be potentially damaged (e.g. bent or scratched) or cause injury to the installer or damage to other materials in proximity to it. Maintenance associated with painting traditional metal framed screens is eliminated.

Another advantage of the system of this invention is that the frameless mesh or screen can be easily made for any size or shape of window opening (including non-rectangular openings, round, oval, etc.). It also enables screens to be made in sizes that are too large for the common metal-framed screen to survive handling. It can also be used on windows which do not include a location for a traditional metal-framed screen.

Another significant advantage of the frameless window screen system is that it can be implemented without reduction of the size of the visual opening of the window. Further, a sagging mesh can be easily stretched taught again by pulling the mesh away from the window frame on one side, stretching it tightly and then reattaching it to the window frame.

Yet another advantage of the system is that the mesh can be more effectively sealed to the window frame at its edges than conventional metal framed screens, thereby preventing insects from entering into the room around the edges. The system of this invention also reduces manufacturer shipping and storage costs for new production windows or replacement screens.

Other advantages and features of the system of this invention will be apparent from the following detailed description and the accompanying drawings.

### BRIEF DESCRIPTION OF THE DRAWINGS

The invention is described in more detail hereinafter with reference to the accompanying drawings where like reference characters refer to the same parts throughout the several views and in which:

FIG. 1 is an isometric exploded view illustrating a window frame, a screen mesh, and a window sash for either an in-swinging or out-swinging rectangular window.

FIG. 2 illustrates the use of a screen system of this invention with a window frame having an in-swinging window sash.

FIG. 3 illustrates the use of a screen system of this invention with a window frame and a common, crank controlled, out-swing window sash.

FIG. 4 illustrates the use of a screen system of this invention on another type of window frame.

FIG. 5 illustrates the use of a screen system of this invention in comparison with a common aluminum framed screen in a typical crank controlled out-swing window frame.

### DETAILED DESCRIPTION OF THE INVENTION

As illustrated in the drawings, the system of this invention involves (a) securing a first strip of fastener material to the outer edges of a screen mesh and (b) securing a second strip of mating fastener material to the edges of a corresponding window frame.

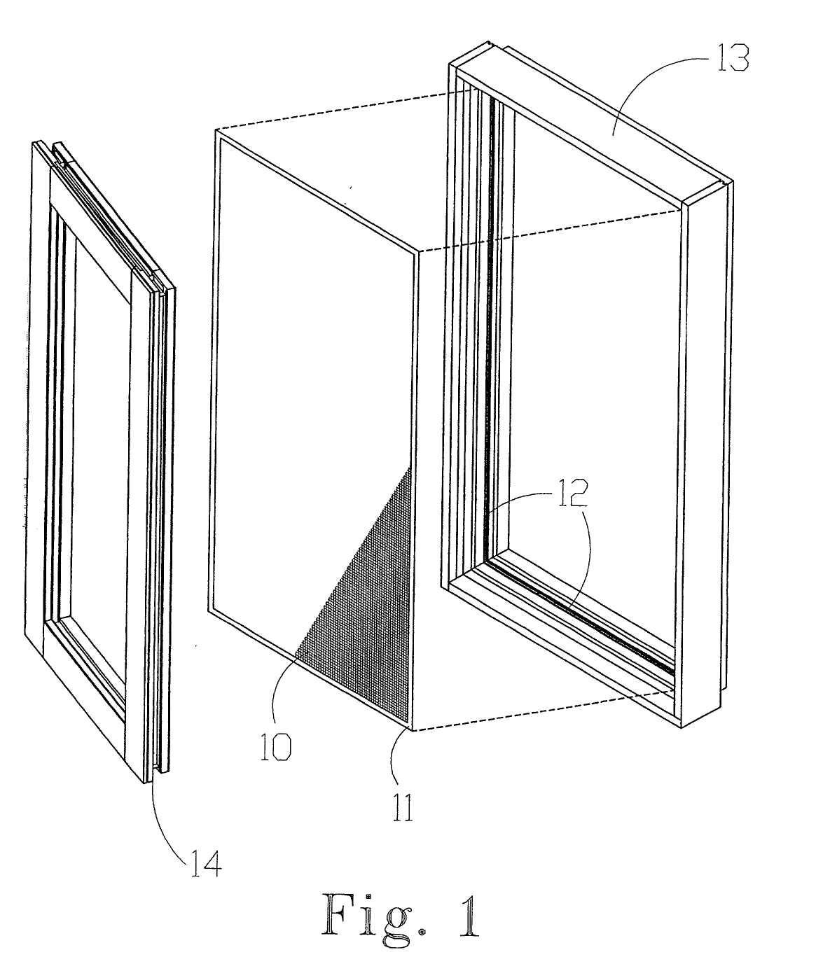

In FIG. 1, the edges of screen mesh 10 have adhered thereto (e.g. with adhesive or with stitching) continues strips of fastener material 11. The window frame 13 has adhered thereto a continuous strip of mating fastener material 12. Thus, whenever the window sash 14 is open, each edge of the screen mesh can be stretched and applied to (i.e. simply pushed against) a corresponding edge of the window frame, whereupon the mesh becomes affixed to the window frame.

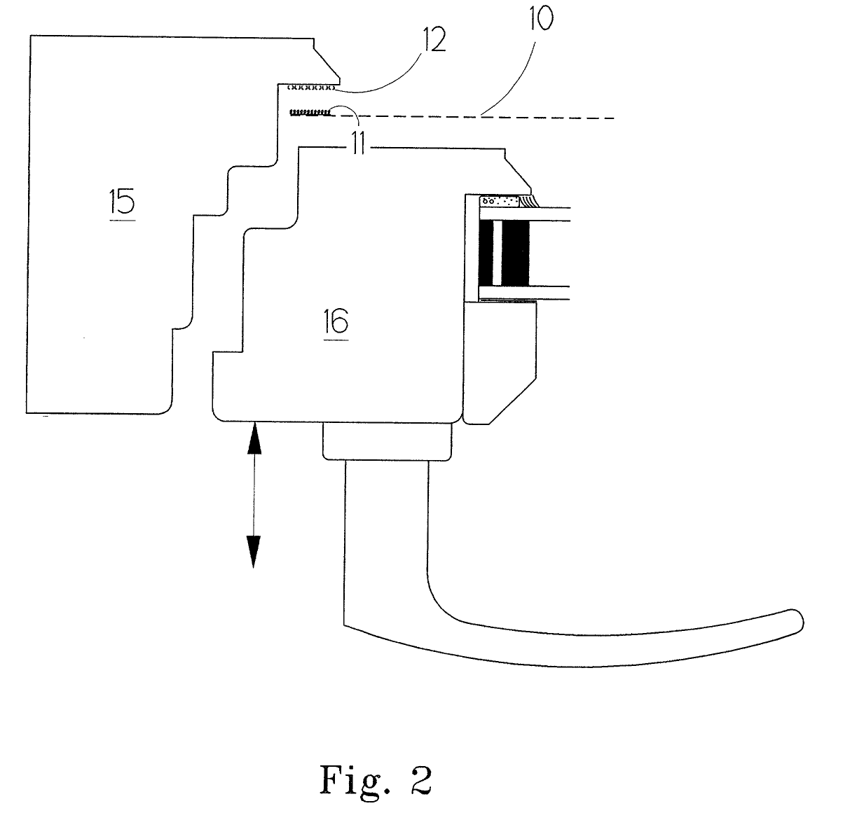

FIG. 2 illustrates a window having fixed frame section 15 and movable in-swinging window sash section 16. A strip 12 of fastener material is secured to the fixed window frame section 15 as shown. The mating strip 11 of fastener material on the edge of the screen mesh can be simply applied to strip 12 to secure it in place without taking up problematic amounts of space with traditional screen frames.

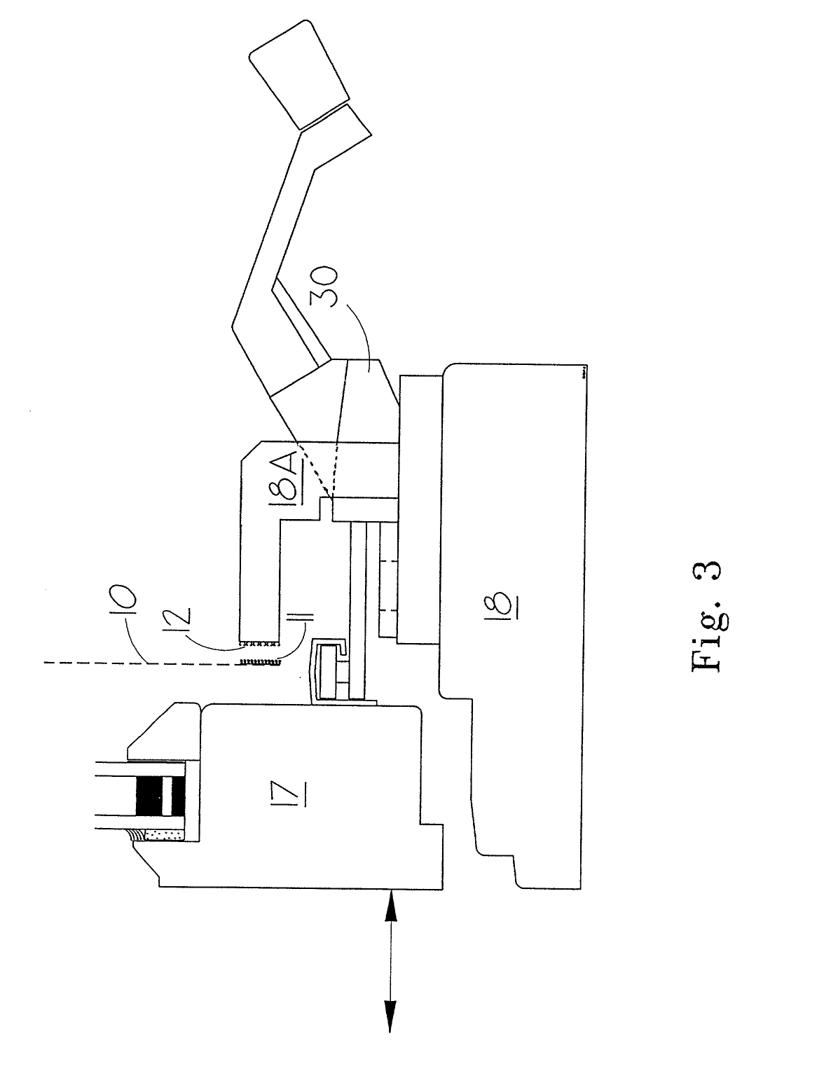

FIG. 3 illustrates another type of window in which the system of the invention may also be used. The fastener strip 12 is secured to window frame section 18A which is the crank housing portion of frame section 18. The screen mesh 10 (with strip 11 on its edge) can be stretched into place and mated with strip 12. The window sash section 17 is moved open or closed through traditional action of the crank hardware assembly 30 without interfering with the screen mesh.

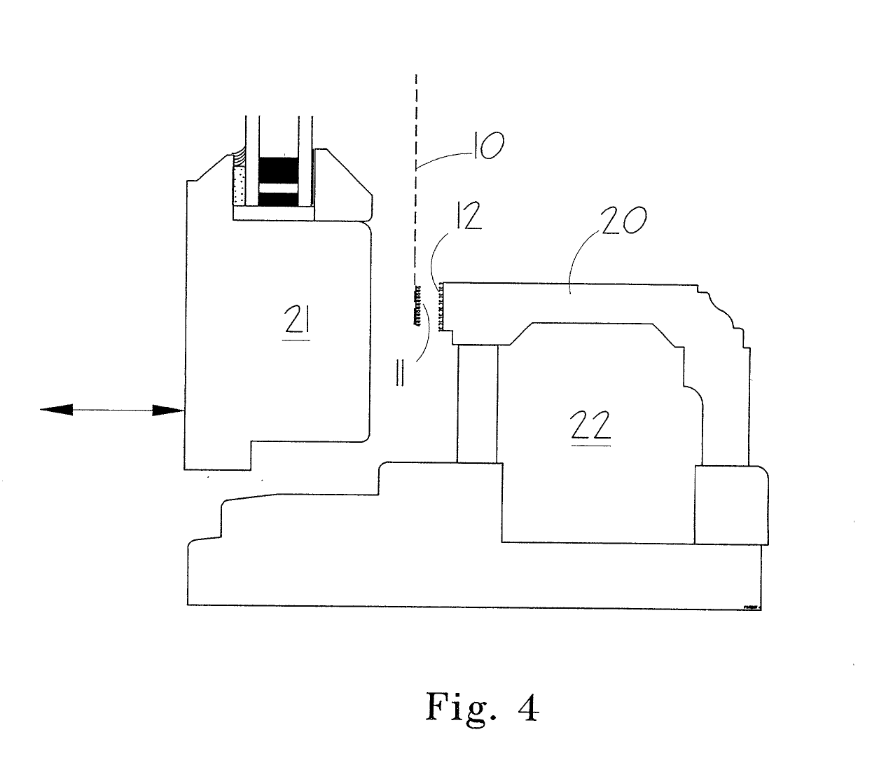

FIG. 4 illustrates use of the screen mesh system on another type of window frame 20. Strip 12 is secured to window frame component 20 at an appropriate location out of view so as to mate with the strip 11 on the edge of mesh 10 without interfering with the electric motor mechanisms mounted in location 22 that operate the window sash section 21.

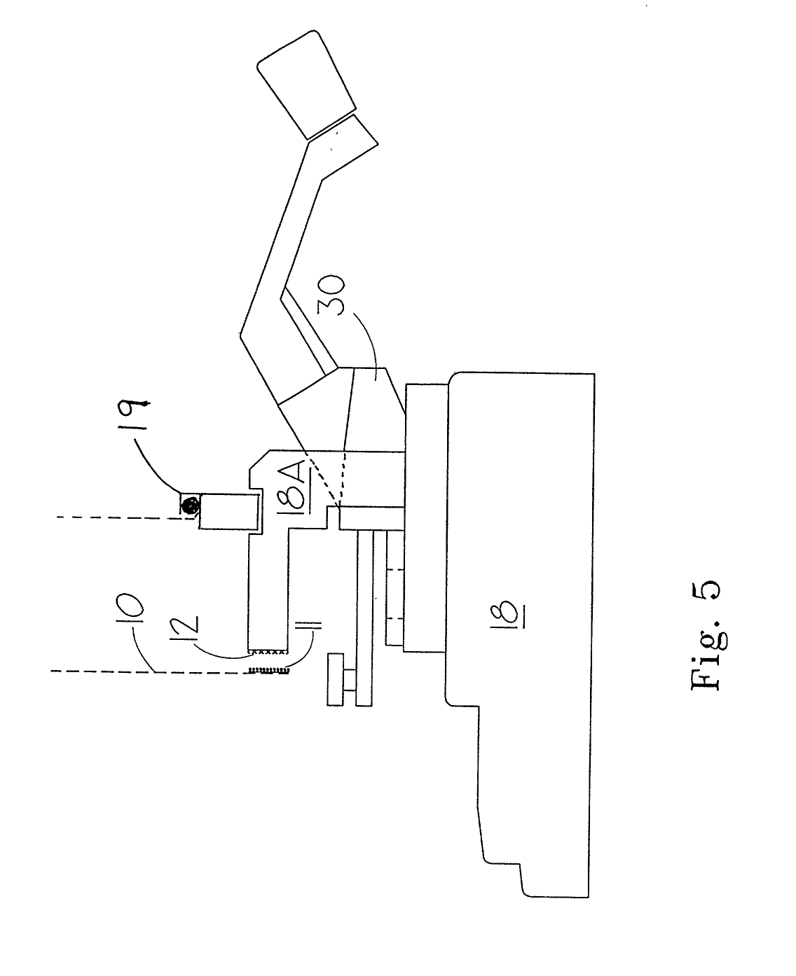

FIG. 5 illustrates how the system of the invention provides for strip 11 on the screen mesh and strip 12 on the window frame section 18A to be located outside of the window's visual opening compared to that visual opening resulting from a traditional metal frame screen 19, provided for reference purposes only, in its most common usage location.

Other variants are possible without departing from the scope of the present invention. For example, the strip 11 can be placed on each face of mesh, if desired. This enables the mesh to be reversed on the window frame for any reason. The system of this invention can also be used on various other types of frames besides those shown in the drawings.

Although it is preferred for the strip of fastener along each edge of the mesh to be a continuous strip, it is possible to use several shorter strips along each edge if that was desired. Also, the width of each fastener strip may vary, as desired. The fastener materials used in this invention are conventional hook and loop fasteners (e.g. VELCRO brand fasteners or other similar hook and loop fasteners which are commercially available.

What is claimed is:

1. A frameless window screen system for use in combination with a conventional window frame, the system comprising:
(a) a screen mesh having side edges;
(b) a first fastener strip secured to said edges of said screen mesh;
(c) a second fastener strip secured to said window frame;
wherein said edges of said screen mesh can be aligned with said window frame in a manner that said first fastener strip mates with said second fastener strip to detachably secure said screen mesh to said window frame; wherein said first and second fastener strips comprise hook and loop fasteners.

2. The system in accordance with claim 1, wherein said screen mesh is rectangular.

3. The system in accordance with claim 1, wherein said screen mesh is non-rectangular.

4. A combination comprising:
(a) a window frame defining an opening;
(b) a screen mesh having a size and shape approximately equal to said opening; said mesh having side edges;
(c) a first fastener strip secured to said side edges of said screen mesh;
(d) a second fastener strip secured directly to said frame around said opening;
wherein said first and second fastener strips comprise hook and loop fasteners; and wherein said side edges of said screen mesh are aligned with said frame around said opening; and wherein said first fastener strip is detachably secured to said second fastener strip, whereby said screen mesh covers said opening.
